(19) United States
(12) Patent Application Publication
(10) Pub. No.: US 2013/0020908 A1
(43) Pub. Date: Jan. 24, 2013

(54) Electro-Mechanical Device Having a Piezoelectric Actuator

(71) Applicants: Vincent POTT, Singapore (SG); Ming Lin Julius Tsai, Singapore (SG)

(72) Inventors: Vincent POTT, Singapore (SG); Ming Lin Julius Tsai, Singapore (SG)

(73) Assignee: Agency for Science, Technology and Research

(21) Appl. No.: 13/527,912

(22) Filed: Jun. 20, 2012

(30) Foreign Application Priority Data
Jun. 23, 2011 (SG) 201104650-5

(51) Int. Cl. H01H 57/00

(52) U.S. Cl. 310/330

(57) ABSTRACT

Embodiments provide an electro-mechanical device. The electro-mechanical device includes a piezoelectric actuator, a first contact electrode and a second contact electrode. The first and second contact electrodes are moveable between a configuration in which they are electrically connected together and a configuration in which they are electrically isolated from each other. The piezoelectric actuator has a deflection element controllable by a first control electrode and a second control electrode. The electro-mechanical device is configured such that a voltage of one polarity applied across the first and second control electrodes causes a deflection of the deflection element which urges the first and second contact electrodes together.

The present application claims the benefit of the Singapore patent application 201104650-5, filed on 23 Jun. 2011, the entire contents of which are incorporated herein by reference for all purposes.

### FIELD OF THE INVENTIONS

Embodiments relate generally to an electro-mechanical device.

### BACKGROUND OF THE INVENTIONS

CMOS (complementary metal-oxide-semiconductor) logic is a technology which is based on the use of CMOS transistors to perform logic functions, and may be used, for example, to implement general computation. Arrays of CMOS transistors may be combined to create logic blocks capable of implementing, for example, sum-of-product functions.

In order to increase computation speed and reduce size of CMOS transistors of CMOS logic, one option is to reduce the channel length of the CMOS transistor. However, this may lead to increase in sub-threshold conduction and thus high leakage power. Reduction in channel length may also cause drain current saturation due to velocity saturation and/or cause other short channel effects.

In order to reduce power consumption of CMOS transistors, one option is to reduce the supply voltage. However, this may lead to lower control over the channel. In addition, threshold voltage may limit supply voltage scaling. Further, lower drain current may lead to lower speed.

### SUMMARY

Various embodiments provide an electro-mechanical device which solves at least partially the above mentioned problems.

In one embodiment, an electro-mechanical device is provided. The electro-mechanical device may include a piezoelectric actuator. The electro-mechanical device may further include a first contact electrode and a second contact electrode. The first and second contact electrodes may be moveable between a first configuration in which they are electrically connected together and a second configuration in which they are electrically isolated from each other. The piezoelectric actuator may include a deflection element controllable by a first control electrode and a second control electrode. The electro-mechanical device may be configured such that a voltage of one polarity applied across the first and second control electrodes causes a deflection of the deflection element which urges the first and second contact electrodes together.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1(a) shows a cross sectional view of an electro-mechanical device according to one exemplary embodiment;

FIG. 1(b) shows a perspective view of the electro-mechanical device shown in FIG. 1(a);

FIG. 2 shows a perspective view of an electro-mechanical device according to one exemplary embodiment;

FIG. 3(a) shows an insulation layer is deposited over a wafer substrate;

FIG. 3(b) shows that a fixed contact electrode is deposited and pattered over the structure shown in FIG. 3(a);

FIG. 3(c) shows a sacrificial layer is deposited over the structure shown in FIG. 3(b), the sacrificial layer covering the fixed contact electrode and part of the insulation layer;

FIG. 3(d) shows a moveable contact electrode and a layer of insulation layer are deposited over the structure shown in FIG. 3(c);

FIG. 3(e) shows a layer of first control electrode, a layer of deflection element, and a layer of second control electrode are deposited over the structure shown in FIG. 3(d) sequentially;

FIG. 3(f) shows that the structure shown in FIG. 3(e) is patterned using photolithography, and etched using combination of wet and dry etching techniques;

FIG. 4 shows simulation results of the relationship between the actuation voltage and the displacement in z direction for electro-mechanical devices in accordance with various embodiments;

FIG. 5 shows simulation results of the relationship between the beam length and the displacement in z direction for electro-mechanical devices in accordance with various embodiments;

FIG. 6 shows simulation results of the relationship between the beam width and the displacement in z direction for electro-mechanical devices in accordance with various embodiments; and

FIG. 7 shows simulation results of the relationship between the gate oxide thickness and the displacement in z direction for electro-mechanical devices in accordance with various embodiments.

### DETAILED DESCRIPTION OF THE INVENTIONS

The following detailed description refers to the accompanying drawings that show, by way of illustration, specific details and embodiments in which the invention may be practiced. These embodiments are described in sufficient detail to enable those skilled in the art to practice the invention. In this regard, directional terminology, such as “top”, “bottom”, “front”, “back”, “leading”, “trailing”, etc, is used with reference to the orientation of the Figure(s) being described. Because components of embodiments can be positioned in a number of different orientations, the directional terminology is used for purposes of illustration and is in no way limiting. Other embodiments may be utilized and structural, logical, and electrical changes may be made without departing from the scope of the invention. The various embodiments are not necessarily mutually exclusive, as some embodiments can be combined with one or more other embodiments to form new embodiments. The following detailed description therefore, is not to be taken in a limiting sense, and the scope of the present invention is defined by the appended claims.

The word “exemplary” is used herein to mean “serving as an example, instance, or illustration”. Any embodiment or design described herein as “exemplary” is not necessarily to be construed as preferred or advantageous over other embodiments or designs.

Various embodiments provide an electro-mechanical device. The electro-mechanical device may include a piezoelectric actuator, a first contact electrode and a second contact electrode. The first and second contact electrodes may be moveable between a first configuration in which they are electrically connected together and a second configuration in which they are electrically isolated from each other. In other words, the first configuration may be transferred into the second configuration, and vice versa. The piezoelectric actuator may have a deflection element controllable by a first control electrode and a second control electrode. The electro-mechanical device may be configured such that a voltage of one polarity applied across the first and second control electrodes causes a deflection of the deflection element which urges the first and second contact electrodes together (e.g. electrically connected). Piezoelectric actuation generally refers to the effect of a dielectric material to get deformed upon application of an electric field.

In one embodiment, in other words, the electro-mechanical device may include a first contact electrode and a second contact electrode. The first and second contact electrodes may be moveable relatively to each other between a first configuration and a second configuration. For example, one of the first and second contact electrodes may be moveable relative to the other one of the first and second contact electrodes. The contact electrode that is moveable relative to the other contact electrode may also be referred to as “moveable contact electrode”, while the other contact electrode may also be referred to as “fixed contact electrode”. In the first configuration, the first and second contact electrodes may be electrically connected together. In the second configuration, the first and second contact electrodes may be electrically isolated (e.g. by a gap) from each other. The electro-mechanical device may further include a piezoelectric actuator. The piezoelectric actuator may include a deflection element. The deflection element may be controllable by the first and second control electrodes which may cause a deflection of the deflection element. For example, when no voltage is applied across the first and second control electrodes, the first and second contact electrodes may be in the second configuration (electrically isolated or disconnected). When a voltage of a first polarity is applied across the first and second control electrodes, the deflection of the deflection element may be deflected in a first direction in a manner to urge the first and second contact electrodes into the first configuration (electrically connected). In one scenario, when the voltage is no longer applied across the first and second control electrodes, the deflection element may be no longer deflected, thereby urging the first and second contact electrodes back into the second configuration. In another scenario, when the voltage is no longer applied across the first and second control electrodes, the adhesion forces (e.g. Van der Waals, metal bonds) between the first and second contact electrodes may be higher than the elastic restoring force of the deflection element. In this case, in one exemplary embodiment, an application of a voltage of a second polarity (which is different from the first polarity) across the first and second control electrodes may cause the deflection element to deflect in a second direction (which is different from the first direction) thereby urging the first and second contact electrodes to be electrically isolated. In this context, the second contact electrode may be referred to as the moveable contact electrode. The first contact electrode may be referred to as the fixed contact electrode.

Illustratively, the first contact electrode may be fixed in position and the second contact electrode may be attached to the piezoelectric actuator and moveable relative to the first contact electrode. Accordingly, the deflection of the deflection element of the piezoelectric actuator may urge the second contact electrode to move towards or away from the first contact electrode depending on the polarity of the voltage applied across the first and second control electrodes. Compared to electrostatic actuators, piezoelectric actuators may achieve stronger actuation force and larger deflection. Piezoelectric actuation may provide a linear displacement-bias characteristic, and achieve displacement of the second contact electrode in either of two opposite directions from the equilibrium position (e.g. the position when the first and second contact electrodes are electrically isolated and no voltage is applied across the first and second control electrodes). Switching time is typically below 1 micro-second, and actuation voltage is generally less than 20 V.

In one embodiment, the electro-mechanical device is configured such that a voltage of another polarity applied across the first and second control electrodes causes a deflection of the deflection element which urges the first and second contact electrodes apart.

In one embodiment, the electro-mechanical device is configured such that an absence of voltage across the first and second control electrodes removes any deflection of the deflection element thereby causing the first and second contact electrodes to be electrically isolated from each other. For example, when no voltage is applied across the first and second control electrodes, the deflection element is not deflected and the first and second contact electrodes may be in the second configuration (electrically isolated). When a voltage of one polarity is applied across the first and second control electrodes, the deflection element may be deflected to urge the first and second contact electrodes into the first configuration (electrically connected together). Thereafter, when the voltage is no longer applied across the first and second control electrodes, the deflection element may be no longer deflected such that the first and second contact electrodes return back to the second configuration (electrically isolated).

In one embodiment, the deflection element is sandwiched between the first and second control electrodes. For example, the application of a voltage of one polarity across the first and second control electrodes may cause the deflection element to deflect in a first direction, and the application of a voltage of another (i.e. opposite) polarity across the first and second control electrodes may cause the deflection element to deflect in a second direction. When the deflection element is deflected in the first direction, the deflection element may be configured to urge the first and second contact electrodes to be electrically connected. When the deflection element is deflected in the second direction, the deflection element may be configured to urge the first and second contact electrodes to be apart from each other.

In one embodiment, one of the contact electrodes is connected to the piezoelectric actuator thereby forming a moveable contact electrode. Illustratively, the second contact electrode may be connected to the piezoelectric actuator. Accordingly, the deflection of the deflection element of the piezoelectric actuator may cause the second contact electrode to move either towards or away from the first contact electrode depending on the polarity of the voltage applied across the first and second control electrodes.

In one embodiment, the other of the contact electrodes is fixed in position thereby forming a fixed contact electrode. Illustratively, the first contact electrode may be fixed in position, e.g. on top of an insulation (or insulating) layer.

In one embodiment, the electro-mechanical device further includes an insulation layer. The fixed contact electrode may be positioned on the insulation layer, and the piezoelectric actuator with the moveable contact electrode may be positioned on top of the fixed contact electrode but spaced therefrom. The moveable contact electrode may be positioned opposite the fixed contact electrode. The piezoelectric actuator may have at least one portion which is connected to the insulation layer.

In a further embodiment, the piezoelectric actuator may have two portions which are connected to the insulation layer. The two portions may be on either side of the fixed contact electrode.

In a further embodiment, the electro-mechanical device further includes a wafer substrate, wherein the insulation layer is positioned on the wafer substrate.

In one embodiment, the electro-mechanical device is configured so that in the absence of voltage across the first and second control electrodes, adhesion forces between the first and second contact electrodes are higher than an elastic restoring force of the piezoelectric actuator. Illustratively, when no voltage is applied across the first and second control electrodes, the first and second contact electrodes may be in the second configuration (electrically isolated). An application of a voltage of one polarity across the first and second control electrodes may cause the deflection element to deflect in a manner to move the moveable contact electrode towards the fixed contact electrode and to bring the first and second contact electrodes in electrical connection. When the voltage is no longer applied, in one embodiment, the adhesion forces between the first and second contact electrodes are higher than the elastic restoring forces of the piezoelectric actuator. In other words, in this embodiment, the first and second contact electrodes remain to be electrically connected even though the voltage is no longer applied across the first and second control electrodes. In this embodiment, the electro-mechanical device may find application as a non-volatile memory device.

In one embodiment, when the first and second contact electrodes are electrically isolated from each other, the first and second contact electrodes are electrically isolated by a gap. A person skilled in the art would appreciate that the first and the second contact electrodes may be electrically isolated by an air gap, a vacuum gap, or a gap filled with a specific gas such as a neutral gas, e.g. nitrogen.

In one embodiment, the electro-mechanical device is configured such that the voltage of one polarity applied across the first and second control electrodes causes a deflection of the deflection element which urges the first and second contact electrodes together and into physical contact.

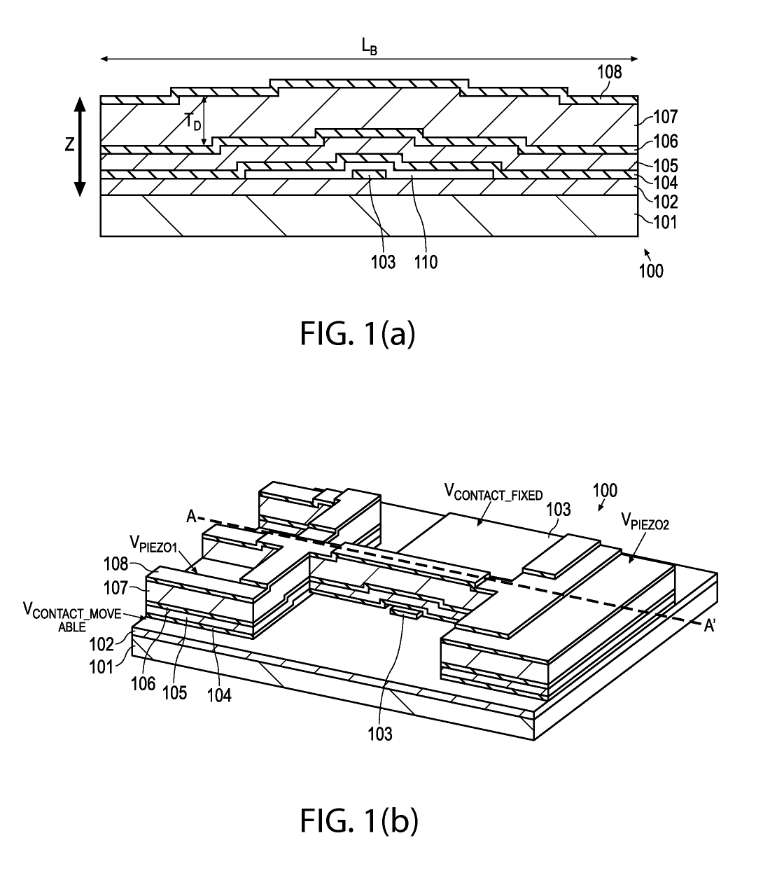

FIG. 1(a) shows a cross sectional view of an electro-mechanical device 100 according to one exemplary embodiment.

The device 100 includes a piezoelectric actuator, a first contact electrode 103 and a second contact electrode 104. The first and second contact electrodes 103 and 104 may be moveable between a first configuration in which they are electrically connected together and a second configuration in which they are electrically isolated from each other. The piezoelectric actuator may have a deflection element 107 controllable by a first control electrode 106 and a second control electrode 108. The electro-mechanical device 100 may be configured such that a voltage of one polarity applied across the first and second control electrodes 106 and 108 causes a deflection of the deflection element 107 which urges the first and second contact electrodes 103 and 104 together.

Illustratively, the first contact electrode 103 may be fixed in position. The second contact electrode 104 may be moveable relative to the first contact electrode 103 and attached to the piezoelectric actuator. Accordingly, the deflection of the deflection element 107 of the piezoelectric actuator may urge the second contact electrode 104 to move towards or away from the first contact electrode 103.

All electrodes 103, 104, 106 and 108 may be controlled separately. When a voltage bias is applied between the control electrodes 106 and 108, then the whole piezoelectric actuator beam (which includes the deflection element 107, and the control electrodes 106 and 108) may deflect, and eventually the moveable electrode 104 and the fixed electrode 103 may be electrically shorted together, making a switch operation. The electro-mechanical device 100 may operate as a logic switch.

In one embodiment, the electro-mechanical device 100 is configured such that a voltage of another polarity applied across the first and second control electrodes 106 and 108 causes a deflection of the deflection element 107 which urges the first and second contact electrodes 103 and 104 apart.

In one embodiment, the electro-mechanical device 100 is configured such that an absence of voltage across the first and second control electrodes 106 and 108 removes any deflection of the deflection element 107, thereby causing the first and second contact electrodes 103 and 104 to be electrically isolated from each other. For example, when no voltage is applied across the first and second control electrodes 106 and 108, the deflection element 107 is not deflected and the first and second contact electrodes 103 and 104 may be in the second configuration (electrically isolated). When a voltage of one polarity is applied across the first and second control electrodes 106 and 108, the deflection element 107 may be deflected to urge the first and second contact electrodes 103 and 104 into the first configuration (electrically connected together). Thereafter, when the voltage is no longer applied across the first and second control electrodes 106 and 108, the deflection element 107 may be no longer deflected such that the first and second contact electrodes 103 and 104 return back to the second configuration (electrically isolated).

In one embodiment, the deflection element 107 is sandwiched between the first and second control electrodes 106 and 108. For example, the application of a voltage of one polarity across the first and second control electrodes 106 and 108 may cause the deflection element 107 to deflect in a first direction, and the application of a voltage of another polarity across the first and second control electrodes 106 and 108 may cause the deflection element 107 to deflect in a second direction. When the deflection element 107 is deflected in the first direction, the deflection element 107 may be configured to urge the first and second contact electrodes 103 and 104 to be electrically connected. When the deflection element 107 is deflected in the second direction, the deflection element 107 may be configured to urge the first and second contact electrodes 103 and 104 to be apart from each other.

In one embodiment, the second contact electrode 104 is connected to the piezoelectric actuator thereby forming a moveable contact electrode. Accordingly, the deflection of the deflection element 107 may cause the second contact electrode 104 to move either towards or away from the first contact electrode 103 depending on the polarity of the voltage applied across the first and second control electrodes 106 and 108.

In one embodiment, the first contact electrode 103 is fixed in position thereby forming a fixed contact electrode.

In one embodiment, the electro-mechanical device 100 further includes an insulation layer 102. The fixed contact electrode 103 may be positioned on the insulation layer 102, and the piezoelectric actuator with the moveable contact electrode 104 may be positioned on top of the fixed contact electrode 103 but spaced therefrom. The moveable contact electrode 104 may be positioned opposite the fixed contact electrode 103. The piezoelectric actuator may have at least one portion which is connected to the insulation layer 102. In a further embodiment, the piezoelectric actuator may have two portions which are connected to the insulation layer 102. As shown in FIG. 1(a), the two portions may be on either side of the fixed contact electrode 103.

In a further embodiment, the electro-mechanical device 100 further includes a wafer substrate 101, and the insulation layer 102 is positioned on the wafer substrate 101.

In one embodiment, the electro-mechanical device 100 is configured so that in the absence of voltage across the first and second control electrodes 106 and 108, adhesion forces between the first and second contact electrodes 103 and 104 are higher than an elastic restoring force of the piezoelectric actuator. Illustratively, when no voltage is applied across the first and second control electrodes 106 and 108, the first and second contact electrodes 103 and 104 may be in the second configuration (electrically isolated). An application of a voltage of one polarity across the first and second control electrodes 106 and 108 may cause the deflection of the deflection element 107, thereby moving the moveable contact electrode 104 towards the fixed contact electrode 103 (e.g. along the z direction as labeled in FIG. 1(a)) and bringing the first and second contact electrodes 103 and 104 in electrical connection. When the voltage is no longer applied, in one embodiment, the adhesion forces between the first and second contact electrodes 103 and 104 are higher than the elastic restoring forces of the piezoelectric actuator. In other words, in this embodiment, the first and second contact electrodes 103 and 104 remain to be electrically connected even though the voltage is no longer applied.

In one embodiment, when the first and second contact electrodes 103 and 104 are electrically isolated from each other, the first and second contact electrodes 103 and 104 are electrically isolated by a gap 110.

In one embodiment, the electro-mechanical device 100 is configured such that the voltage of one polarity applied across the first and second control electrodes 106 and 108 causes a deflection of the deflection element 107 which urges the first and second contact electrodes 103 and 104 together and into physical contact.

In one embodiment, the beam length L_{B} (i.e. the length of the piezoelectric actuator as shown in FIG. 1(a)) may be in the range from about 5 μm to 100 μm. The beam width may be in the range from about 1 μm to 10 μm or 10% of the beam length L_{B}. The thickness T_{D} of the deflection element layer 107 may be around 0.35 μm. The gate oxide thickness (e.g. the thickness of gate oxide layer 102 or 105) may be between about 0.01 to 1 μm. The electrode thickness (i.e. the thickness of each of the first and second control electrodes 106 and 108, the moveable contact electrode 104 and the fixed contact electrode 103) may be around 0.1 μm. The air gap 110 may be between around 5 nm to 80 nm. The actuation voltage may be in the range from 2 V to 25 V. However, it should be noted that the dimension of each part above is only for illustration purpose and should not be limited thereto.

FIG. 1(b) shows a perspective view of the electro-mechanical device 100. The AA′ cross-section of the electro-mechanical device 100 shown in FIG. 1(b) corresponds to the one shown in FIG. 1(a). The electro-mechanical device 100 may also be referred to as 4-terminal piezoelectric device. In FIGS. 1(a) and (b), the state of the device 100 may be referred to as in the off-state (i.e. the moveable contact electrode 104 and the fixed contact electrode 103 are electrically isolated). Actuation (z-displacement of the beam) may be performed via biasing metal electrodes 106 and 108. The electro-mechanical contact is made between contact electrodes 104 and 103. A voltage V_{PIEZO1} may be applied to the first control electrode 106. A voltage V_{PIEZO2} may be applied to the second control electrode 108. A voltage V_{CONTACT}_{_{—}}_{FIXED} may be measured at or applied to the fixed contact electrode 103. A voltage V_{CONTACT}_{_{—}}_{MOVEABLE} may be measured at or applied to the moveable contact electrode 104. In other words, each of the first and second contact electrodes, and the first and second control electrodes may be controlled separately.

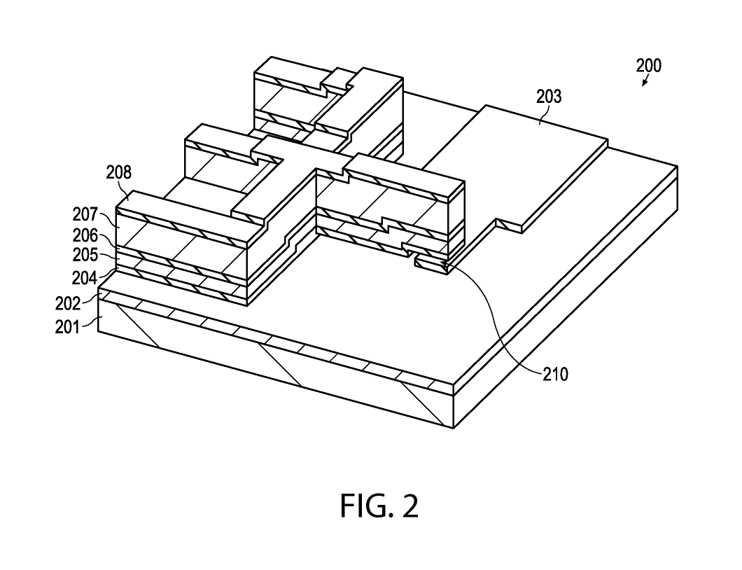

FIG. 2 shows a perspective view of an electro-mechanical device 200 according to one exemplary embodiment.

The device 200 includes a piezoelectric actuator, a first contact electrode 203 and a second contact electrode 204. The first and second contact electrodes 203 and 204 may be moveable between a first configuration in which they are electrically connected together and a second configuration in which they are electrically isolated from each other. The piezoelectric actuator may have a deflection element 207 controllable by a first control electrode 206 and a second control electrode 208. The electro-mechanical device 200 may be configured such that a voltage of one polarity applied across the first and second control electrodes 206 and 208 causes a deflection of the deflection element 207 which urges the first and second contact electrodes 203 and 204 together.

Illustratively, the first contact electrode 203 may be fixed in position. The second contact electrode 204 may be moveable relative to the first contact electrode 203 and attached to the piezoelectric actuator. Accordingly, the deflection of the deflection element 207 of the piezoelectric actuator may urge the second contact electrode 204 to move towards or away from the first contact electrode 203.

All electrodes 203, 204, 206 and 208 may be controlled separately. When a voltage bias is applied between the control electrodes 206 and 208, then the whole piezoelectric actuator beam (which includes the deflection element 207, and the control electrodes 206 and 208) may deflect, and eventually the moveable electrode 204 and the fixed electrode 203 may be shorted together, making a switch operation. The electro-mechanical device 200 may operate as a logic switch.

In one embodiment, the electro-mechanical device 200 is configured such that a voltage of another polarity applied across the first and second control electrodes 206 and 208 causes a deflection of the deflection element 207 which urges the first and second contact electrodes 203 and 204 apart.

In one embodiment, the electro-mechanical device 200 is configured such that an absence of voltage across the first and second control electrodes 206 and 208 removes any deflection of the deflection element 207, thereby causing the first and second contact electrodes 203 and 204 to be electrically isolated from each other. For example, when no voltage is applied across the first and second control electrodes 206 and 208, the deflection element 207 is not deflected and the first and second contact electrodes 203 and 204 may be in the second configuration (electrically isolated). When a voltage of one polarity is applied across the first and second control electrodes 206 and 208, the deflection element 207 may be deflected to urge the first and second contact electrodes 203 and 204 into the first configuration (electrically connected together). Thereafter, when the voltage is no longer applied across the first and second control electrodes 206 and 208, the deflection element 207 may be no longer deflected such that the first and second contact electrodes 203 and 204 return back to the second configuration (electrically isolated).

In one embodiment, the deflection element 207 is sandwiched between the first and second control electrodes 206 and 208. For example, the application of a voltage of one polarity across the first and second control electrodes 206 and 208 may cause the deflection element 207 to deflect in a first direction, and the application of a voltage of another polarity across the first and second control electrodes 206 and 208 may cause the deflection element 207 to deflect in a second direction. When the deflection element 207 is deflected in the first direction, the deflection element 207 may be configured to urge the first and second contact electrodes 203 and 204 to be electrically connected. When the deflection element 207 is deflected in the second direction, the deflection element 207 may be configured to urge the first and second contact electrodes 203 and 204 to be apart from each other.

In one embodiment, the second contact electrode 204 is connected to the piezoelectric actuator thereby forming a moveable contact electrode. Accordingly, the deflection of the deflection element 207 may cause the second contact electrode 204 to move either towards or away from the first contact electrode 203 depending on the polarity of the voltage applied across the first and second control electrodes 206 and 208.

In one embodiment, the first contact electrode 203 is fixed in position thereby forming a fixed contact electrode.

In one embodiment, the electro-mechanical device 200 further includes an insulation layer 202. The fixed contact electrode 203 may be positioned on the insulation layer 202, and the piezoelectric actuator with the moveable contact electrode 204 may be positioned on top of the fixed contact electrode 203 but spaced therefrom. The moveable contact electrode 204 may be positioned opposite the fixed contact electrode 203. The piezoelectric actuator may have one portion which is connected to the insulation layer 202. The electro-mechanical device 200 is similar to the electro-mechanical device 100. The device 200 is different from the device 100 in that for device 200, the piezoelectric actuator has one portion being connected to the insulation layer 202, while for device 100, the piezoelectric actuator has two portions being connected to the insulation layer 102. In this context, the device 100 may also be referred to as an electro-mechanical device of a clamped-clamped beam type, and the device 200 may also be referred to as an electro-mechanical device of a single-clamped beam type.

In a further embodiment, the electro-mechanical device 200 further includes a wafer substrate 201, and the insulation layer 202 is positioned on the wafer substrate 201.

In one embodiment, the electro-mechanical device 200 is configured so that in the absence of voltage across the first and second control electrodes 206 and 208, adhesion forces between the first and second contact electrodes 203 and 204 are higher than an elastic restoring force of the piezoelectric actuator. Illustratively, when no voltage is applied across the first and second control electrodes 206 and 208, the first and second contact electrodes 203 and 204 may be in the second configuration (electrically isolated). An application of a voltage of one polarity across the first and second control electrodes 206 and 208 may cause the deflection of the deflection element 207, thereby moving the moveable contact electrode 204 towards the fixed contact electrode 203 (e.g. along the z direction as labeled in FIG. 2 and bringing the first and second contact electrodes 203 and 204 in electrical connection. When the voltage is no longer applied, in one embodiment, the adhesion forces between the first and second contact electrodes 203 and 204 are higher than the elastic restoring forces of the piezoelectric actuator. In other words, in this embodiment, the first and second contact electrodes 203 and 204 remain to be electrically connected even though the voltage is no longer applied.

In one embodiment, when the first and second contact electrodes 203 and 204 are electrically isolated from each other, the first and second contact electrodes 203 and 204 are electrically isolated by a gap 210.

In one embodiment, the electro-mechanical device 200 is configured such that the voltage of one polarity applied across the first and second control electrodes 206 and 208 causes a deflection of the deflection element 207 which urges the first and second contact electrodes 203 and 204 together and into physical contact.

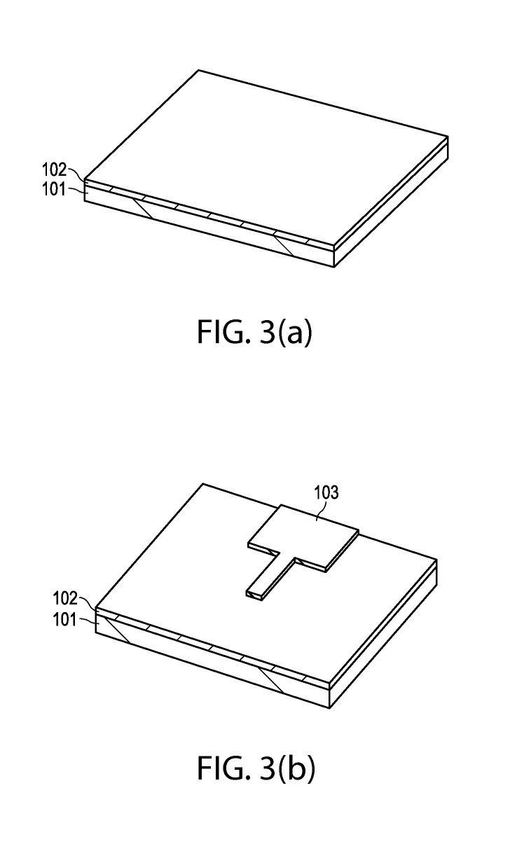

FIGS. 3(a) to (f) illustrate a possible fabrication process of the electro-mechanical device 100 according to one exemplary embodiment.

FIG. 3(a) shows that a layer of insulation material 102 is deposited on top of a wafer substrate 101.

FIG. 3(b) shows that the fixed conductive electrode (e.g. conductive electrode) 103 is deposited over the layer 102 of insulation material and patterned.

FIG. 3(c) shows that a sacrificial layer 120 is deposited over the fixed metallic electrode 103 and the insulation layer 102. The sacrificial layer 120 is patterned and covers the fixed electrode 103.

FIG. 3(d) and FIG. 3(e) show that a moveable beam is deposited on top of the sacrificial layer. In FIG. 3(d), the metal layer 104 and the insulation layer 105 are deposited over the structure shown in FIG. 3(c). In FIG. 3(e), the first control electrode 106, the piezoelectric material 107, and the electrode 108 are deposited over the structure shown in FIG. 3(d).

After deposition of the first and second contact electrodes 103 and 104, the insulation layer 105, the first control electrode 106, the deflection element 107 and the second control electrode 108 illustrated in FIGS. 3(b) to (e), in FIG. 3(f), the beam (which includes the first and second control electrodes 106 and 108 and the deflection element 107) and contact electrode 104 are patterned using photolithography, and etched using a combination of wet/dry etching techniques.

The structure may be finally released with a dry etch process of the sacrificial layer 120, thereby obtaining the electro-mechanical device shown in FIG. 1(b).

For example, materials used for the substrate 101 may be silicon or glass. The dielectric layers 102 and 105 may include at least one of silicon nitride, aluminum oxide, and silicon oxide. The contact electrodes 103 and 104 may include at least one of platinum, ruthenium, titanium nitride and tantalum nitride. The piezoelectric actuator electrodes 106 and 108 may include at least one of aluminum and molybdenum. The deflection element 107 may include at least one of quartz, lithium niobate, lithium tantalite, aluminum nitride, zinc oxide and PZT (PZT refers to a solid solution of lead, zirconate and titanate, having a high piezoelectric coefficient). The sacrificial layer may include a silicon based material (e.g. silicon oxide, or deposited amorphous silicon), and may be released with a dry etching process (HF-vapor for silicon oxide, XeF2 for amorphous silicon). The fabrication process may be optimized to release any residual stress which may remain in the beam, and resulting in uncontrolled buckling of the beam. This may be done by process optimization, thermal (or laser) annealing, and stress compensation techniques. Particularly, the clamped-clamped beam structure is robust against tensile stress due to its geometry.

The fabrication process for the device 200 may be similar as for the device 100 except that the mask in the photolithography used during the fabrication may be different.

Depending on the polarity of the voltage applied across the control electrodes (e.g. V_{PIEZO1} and V_{PIEZO2}), the beam may move in the two opposite directions along the z-axis, closing or opening a gap (the gap may be about 5 nm to 200 nm), and thereby close or open an ohmic (resistive) contact between V_{CONTACT}_{_{—}}_{MOVEABLE} and V_{CONTACT}_{_{—}}_{FIXED}. An advantage of the piezoelectric switch design is that the device may be actively turned off by the applied actuation voltage. This helps to overcome issues due to adhesion forces in the contact region. In one embodiment the switch is a normally-OFF structure, in the sense that the first and second contact electrodes do not make contact after the release of the voltage applied across the first and second control electrodes. The signal to switch flows either from the moveable contact to the fixed electrode, or in opposite direction, when the switch is closed (e.g. electrical contact between the two contact electrodes).

As adhesion forces (e.g. Van der Waals, metal bonds) naturally builds-up in the contact area, then the same structure may be used as a non-volatile memory. If the device is designed (in respects of lateral dimensions, thickness of layers, and choice of material) in such a way that adhesion forces at the contact are higher than the elastic restoring force of the beam when the switch is closed, then it may operate as a non-volatile memory.

Mechanical bi-stability may be achieved when the device is powered off (either contact or non-contact), resulting in permanent data storage. The very small proof mass of the beam makes the structure suitable for harsh environment (vibrations, radiations). The electro-mechanical device as described herein may be designed to store information and to operate at high temperature (T>200° C.), as adhesion forces increase when temperature increases. Reading of the memory may be done by probing the contact resistance, and may keep an excellent ON/OFF ratio, even at high temperature.

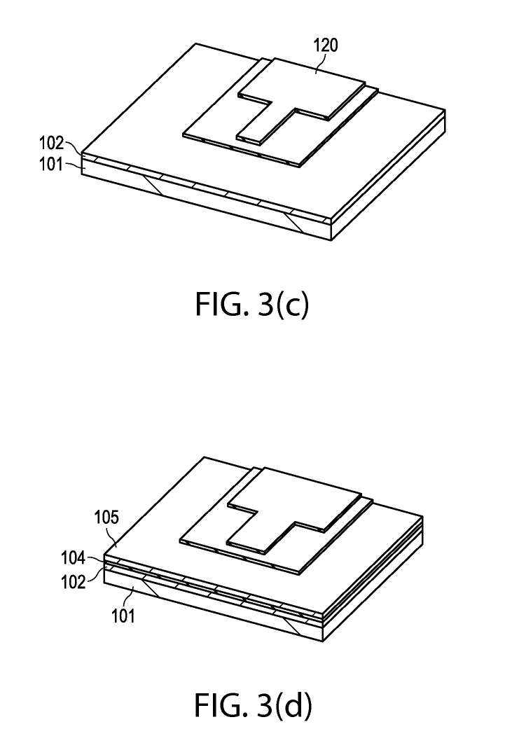

FIG. 4 shows simulation results of the relationship between the voltage applied across the first and second control electrodes and the displacement of the moveable contact electrode for both an electro-mechanical device of clamped-clamped beam type and a single-clamped beam type. The horizontal axis is the voltage applied, and the vertical axis is the displacement. For both electro-mechanical devices, the beam length is about 20 μm, the beam width is about 3 μm, the thickness of the deflection element which includes AlN is about 0.35 μm. The thickness of the gate oxide is about 0.1 μm. It shows that upon application of a same voltage, the displacement for the electro-mechanical device of single-clamped type is larger than that of the electro-mechanical device of clamped-clamped type.

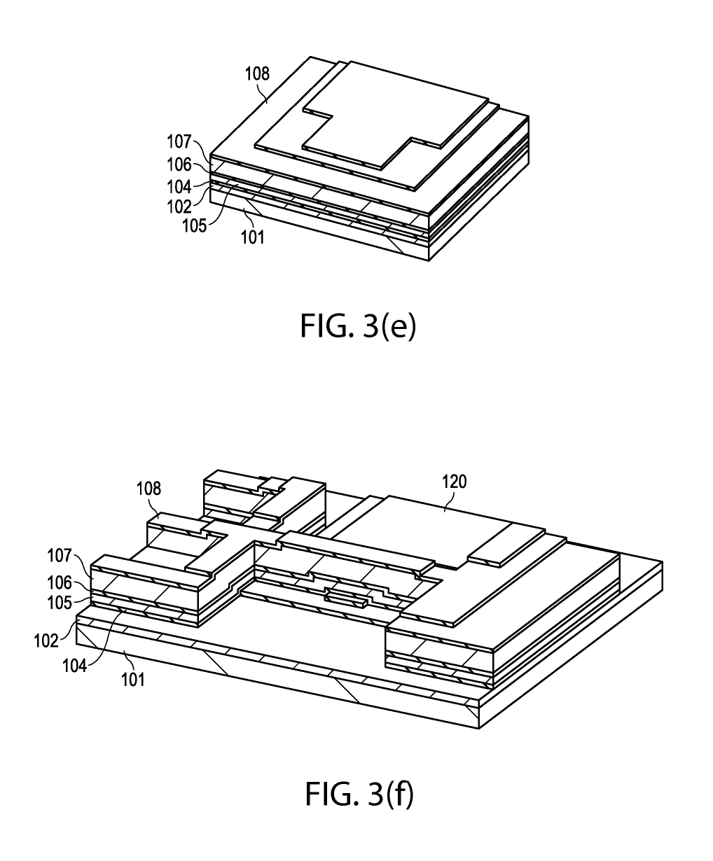

FIG. 5 shows simulation results of the relationship between the beam length and the displacement in the z direction for both an electro-mechanical device of clamped-clamped beam type and single-clamped beam type. The horizontal axis is the beam length, and the vertical axis is the displacement in the Z direction. The beam width for both devices is about 1 μm. The thickness of the deflection element which includes AlN is about 0.35 μm. The thickness of the gate oxide is about 0.4 μm. The actuation voltage is 10 V. It shows that with a same beam length and same actuation voltage, the displacement in the z direction for the electro-mechanical device of single-clamped beam type is larger than that of the electro-mechanical device of clamped-clamped beam type.

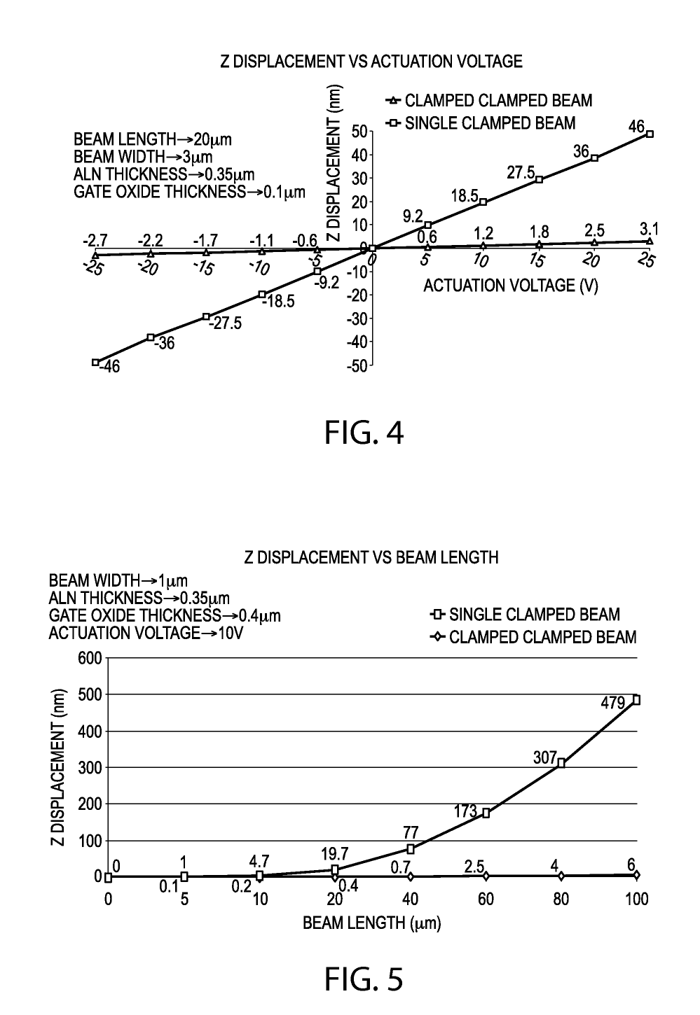

FIG. 6 shows simulation results of the relationship between the beam width and displacement in the z direction for both an electro-mechanical device of clamped-clamped beam type and single-clamped beam type. The horizontal axis is the beam width, and the vertical axis is the displacement in the z direction. The beam length for both devices is about 40 μm. The thickness of the deflection element which includes AlN is about 0.35 μm. The thickness of the gate oxide is about 0.4 μm. The actuation voltage is 10 V. It shows that with a same beam width, the displacement for the electro-mechanical device of single-clamped beam type is larger than that of the electro-mechanical device of the clamped-clamped beam type.

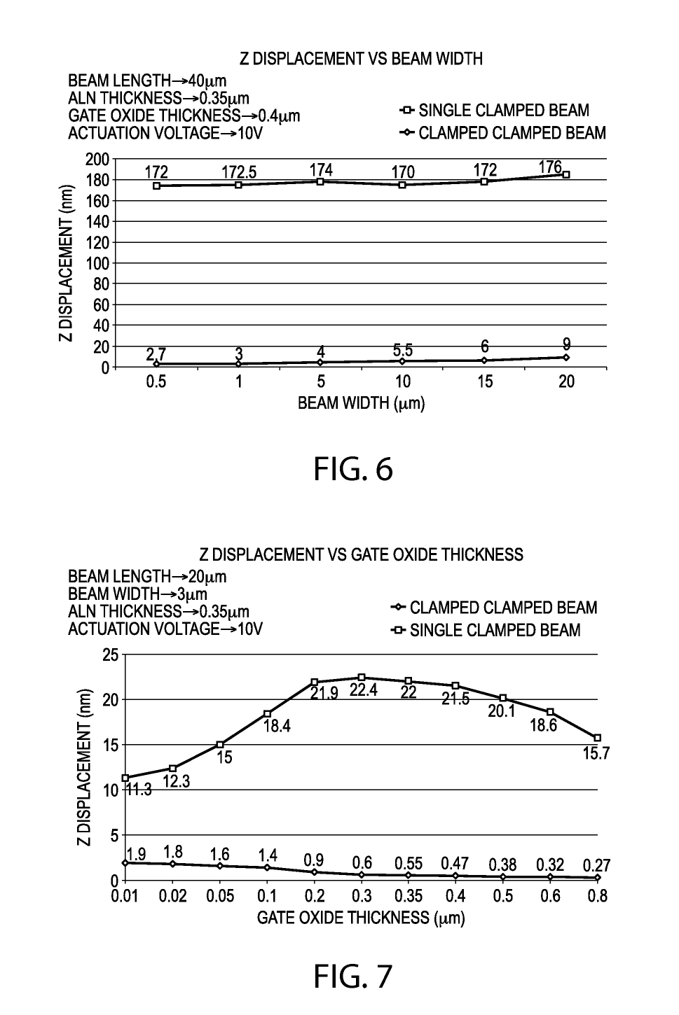

FIG. 7 shows simulation results of the relationship between the gate oxide thickness and the displacement in the z direction for both an electro-mechanical device of clamped-clamped beam type and single-clamped beam type. The beam length for both devices is 20 μm. The beam width is about 3 μm. The thickness of the deflection element which includes AlN is about 0.35 μm. The actuation voltage is 10 V. It shows that with a same gate oxide thickness, the displacement for the electro-mechanical device of single-clamped beam type is larger than that of the electro-mechanical device of the clamped-clamped beam type.

Various embodiments provide a 4-terminal piezoelectric-actuated micro-electro-mechanical system (MEMS) which has applications either as a logic switch or as a non-volatile memory. The electro-mechanical device has a simple structure and process-flow, and may be scaled down to achieve medium to high density integration. The excellent scalability of the structure is important for computation and data storage. The fabrication process of the electro-mechanical device as described herein involves only standard photolithography, and masks used are used to define pretty large dimensions. No spacers are used between the electrodes, and thus there is very limited risk of shorts between electrodes. The whole piezoelectric actuator may be deposited in one run, and is thus easy to fabricate.

The electro-mechanical device as described herein also has the advantage that leakage current is practically zero, due to the presence of a gap. The operational voltage could be lowered as low as hundreds of mV. Compared with CMOS logic, passive leakage power as well as active power consumption may be reduced. Further, there is no gate oxide related issues.

The electro-mechanical device as described herein may find applications, for example, as a logic switch (complementary switching of DC signals, with zero current leakage in the OFF-state, power gating), and as a non-volatile memory (high-temperature data storage), non-volatility being obtained by adhesion forces in the contact.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. An electro-mechanical device comprising:
a piezoelectric actuator;
a first contact electrode and a second contact electrode, the first and second contact electrodes being moveable between a configuration in which they are electrically connected together and a configuration in which they are electrically isolated from each other;
the piezoelectric actuator having a deflection element controllable by a first control electrode and a second control electrode, the electro-mechanical device being configured such that a voltage of one polarity applied across the first and second control electrodes causes a deflection of the deflection element which urges the first and second contact electrodes together.

2. The electro-mechanical device of claim 1, wherein the electro-mechanical device is configured such that a voltage of another polarity applied across the first and second control electrodes causes a deflection of the deflection element which urges the first and second contact electrodes apart.

3. The electro-mechanical device of claim 1, wherein the electro-mechanical device is configured such that an absence of voltage across the first and second control electrodes removes any deflection of the deflection element thereby causing the first and second contact electrodes to be electrically isolated from each other.

4. The electro-mechanical device of claim 1, wherein the electro-mechanical device is configured so that in the absence of voltage across the first and second control electrodes adhesion forces between the first and second contact electrodes are higher than an elastic restoring force of the piezoelectric actuator.

5. The electro-mechanical device of claim 1, wherein the deflection element is sandwiched between the first and second control electrodes.

6. The electro-mechanical device of claim 1, wherein one of the contact electrodes is connected to the piezoelectric actuator thereby forming a moveable contact electrode.

7. The electro-mechanical device of claim 6, wherein the other of the contact electrodes is fixed in position thereby forming a fixed contact electrode.

8. The electro-mechanical device of claim 7, further comprising an insulation layer, wherein the fixed contact electrode is positioned on the insulation layer and the piezoelectric actuator with the moveable contact electrode is positioned on top of the fixed contact electrode but spaced therefrom, the moveable contact electrode being positioned opposite the fixed contact electrode, the piezoelectric actuator having at least one portion which is connected to the insulation layer.

9. The electro-mechanical device of claim 8, wherein the piezoelectric actuator has two portions which are connected to the insulation layer, the two portions being either side of the fixed contact electrode.

10. The electro-mechanical device of claim 8, further comprising a wafer substrate, wherein the insulation layer is positioned on the wafer substrate.

11. The electro-mechanical device of claim 1, wherein when the first and second contact electrodes are electrically isolated from each other, the first and second contact electrodes are electrically isolated by a gap.

12. The electro-mechanical device of claim 1, wherein the electro-mechanical device is configured such that the voltage of one polarity applied across the first and second control electrodes causes a deflection of the deflection element which urges the first and second contact electrodes together and into physical contact.
